(19) United States
(12) Patent Application Publication
(10) Pub. No.: US 2025/0276511 A1
(43) Pub. Date: Sep. 4, 2025

(54) LAMINATED SLEEVE WITH SUPPORT LAYER OF SPLICED STRUCTURE AND MANUFACTURING METHOD THEREOF

(71) Applicant: Auclean High - Tech (Wuxi) Ltd, Wuxi (CN)

(72) Inventors: Ting GUI, Wuxi (CN); Yanli WANG, Wuxi (CN); Yuguang GUI, Wuxi (CN)

(21) Appl. No.: 19/208,699

(22) Filed: May 15, 2025

Related U.S. Application Data
(63) Continuation of application No. PCT/CN2024/104153, filed on Jul. 8, 2024.

(30) Foreign Application Priority Data
May 8, 2023 (CN) 202310508906.3

(51) Int. Cl. B41C 1/18; B29D 23/00; B29K 63/00; B29K 309/08; B32B 1/08; B32B 5/02; B32B 17/04; B32B 27/12; B32B 27/28; B32B 27/30; B32B 27/38; B41N 6/00

(52) U.S. Cl. CPC B41C 1/182; B29D 23/00; B32B 1/08; B32B 5/024; B32B 17/04; B32B 27/12; B32B 27/281; B32B 27/304; B32B 27/38; B41N 6/00; B29K 2063/00; B29K 2309/08; B32B 2260/021; B32B 2260/046; B32B 2262/101; B32B 2597/00

(57) ABSTRACT

A laminated sleeve includes: a basic sleeve, an elastic layer, an inner reinforcement layer, a support layer, an outer reinforcement layer and a surface layer which are sequentially arranged in that order from inside to outside. A manufacturing method includes: cutting a plate material into support strips of the same size, arranging the support strips around a central axis of the sleeve to cover the inner reinforcement layer annularly to obtain the support layer, wrapping the outer reinforcement layer around the support layer, and obtaining the laminated sleeve after surface processing. The manufacturing method greatly expands the wide range of material choices for the support layer and allows for flexible adjustment of the outer diameter size of the product. The support layer of the laminated sleeve made by the disclosure can be made of general rigid solid materials with low density, high strength, and minimal deformation.

### CROSS-REFERENCE TO RELATED APPLICATIONS

This application is a continuation of International Patent Application No. PCT/CN2024/104153, filed Jul. 8, 2024, which claims the priority of Chinese Patent Application No. 202310508906.3, filed May 8, 2023, both of which are herein incorporated by reference in their entirety.

### TECHNICAL FIELD

The disclosure relates to the field of flexographic printing plate rollers, and more particularly to a laminated sleeve with a support layer of a spliced structure and its manufacturing method.

### BACKGROUND

Currently, in the field of printing, packaging, textile, and dyeing equipment, there are two types of rollers (cylinders) including a shafted printing plate roller and a traditional laminated sleeve involved. The shafted printing plate roller is made of all steel or a combination of steel shaft ends and aluminum alloy tube sleeves that is integrated into one piece. However, the shafted printing plate roller has several drawbacks, such as heavy weight, long time and difficulty in loading and unloading, low efficiency, poor safety, and inconvenient storage. The traditional laminated sleeve is used in conjunction with an air-expanding mandrel, and made of fiber reinforced plastic (GFRP) and polymer materials, with a middle filling layer made of polyurethane, synthetic rubber, foaming materials, etc. In the field of flexographic printing, there are requirements for the sleeve in terms of overall weight, ease of sleeve replacement, geometric dimensional stability, cost, hardness and roughness of the surface material, and solvent resistance. By using only one specified diameter mandrel and changing the thickness of the sleeve, different printing circumferences (i.e., different diameters) can be achieved. The middle filling layer in the sleeve provides support at different thicknesses to meet requirements of the flexographic printing.

The support layer of the laminated sleeve currently is made by rotating and casting two-component polyurethane foam onto a tube, and there is also a method of wrapping rubber on a tube followed by vulcanizing at high temperature. For example, a Chinese patent with the publication number CN105500896B discloses a multi-layer composite sleeve, with a structure of cylindrical and a cross-section in a shape of an annulus. The multi-layer composite sleeve consists of an outer layer, a filling layer, a skeleton layer, a buffer layer, and an inner skeleton layer, which are arranged from the outside to the inside. The outer layer is made of thermoplastic material or hard rubber, the filling layer is a polyurethane or rubber hard foam layer, the skeleton layer and the inner skeleton layer are made of glass fiber resin material, and the buffer layer is made of soft rubber or polyurethane foam sponge. In the above solution, the inner skeleton layer and the skeleton layer, made of the glass fiber resin material, make the multi-layer composite sleeve have a certain degree of elasticity, which facilitates assembly with the air-expanding mandrel. The multi-layer composite sleeve is lightweight, with high strength, and safe and reliable during high-speed printing processes. The multi-layer composite structure in the above solution utilizes and leverages characteristics of high molecular materials to closely cooperate with the air-expanding mandrel to complete flexographic printing operations. Polyurethane foam as the middle support layer requires a large investment in production equipment, high energy consumption during the production process, and a large production line area, and is limited to the two-component foaming foam rotation casting process, restricting the selection of other materials. The method of wrapping rubber followed by vulcanizing at high temperatures results in a heavy product, restricted support layer thickness, high thermal expansion coefficient that is prone to deformation, large investment in production equipment, high energy consumption during the production process, large production area, environmental unfriendliness in the production process, and high comprehensive production costs, also limiting the selection of other materials. Moreover, there is also a method of wrapping honeycomb panels around the tube. For instance, a Chinese patent with the publication number CN109049912A discloses a composite roller with a honeycomb structure and its processing method. The composite roller includes a roller core and a composite sleeve. The composite sleeve consists of a GFRP inner bonding layer, a honeycomb panel filling structure layer, a GFRP bonding fixing layer, and a sleeve outer layer, which are arranged from the inside to the outside. The composite sleeve is bonded to the surface of the roller core through the GFRP inner bonding layer. The processing method includes: processing the roller core; winding glass fiber yarn around the roller core for cure to obtain the GFRP inner bonding layer; wrapping the honeycomb panels around the outer surface of the GFRP inner bonding layer to form the honeycomb panel filling structure layer; winding glass fiber yarn around the honeycomb panel filling structure layer for cure to form the GFRP bonding fixing layer; selecting the roller surface material and bonding the sleeve outer layer to the outer surface of the GFRP bonding fixing layer; and grinding and polishing the outer surface of the composite sleeve. The above honeycomb structure can reduce the weight of the composite sleeve, increase the roller speed, reduce energy consumption, enhance the structural strength and stability of the composite roller, and extend its service life. However, the honeycomb panel support layer is costly to form, and has a high manufacturing difficulty. If the thickness of the support layer needs to be increased, there must be multiple layers wrapped, which results in low production efficiency and also limits the selection of other materials. In summary, the above support materials are unable to achieve the ideal thickness dimension in a single processing step when facing large thickness requirements.

### SUMMARY

In view of deficiencies of the related art, the disclosure provides a laminated sleeve with a support layer of a spliced structure and its manufacturing method. The purpose is to solve current technical problems of the intermediate support layer of the sleeve, such as heavy weight, susceptibility to deformation, the need for multiple thickness increases, high cost, complex process, long processing cycle, and especially the limitations in material selection, which in turn restrict the sleeve production.

The disclosure provides a first technical solution being a manufacturing method of a laminated sleeve, includes:
cutting a plate material into support strips, arranging the support strips in an isoperimetric manner around a central axis of the laminated sleeve and between an inner reinforcement layer and an outer reinforcement layer to form a support layer.

In the disclosure, the support strips are mutually spliced along an outer peripheral surface of the inner reinforcement layer and are attached to the inner reinforcement layer. It should be noted that the support layer can achieve a required thickness with just one layer of the plate material that are calculated and cut.

In an embodiment, the support strips are one or more of a frustum structure, a rectangular prism structure and a prism structure.

In an embodiment, each of the support strips is the frustum structure, a number of the support strips is N, where N=180°/arctan(l/2r), r represents an outer radius of the inner reinforcement layer, l represents a minimum width of each of the support strips, l=Lr/(r+h), L represents a maximum width of each of the support strips, and h represents a thickness of the support layer. The parameters can be flexibly adjusted according to product specifications, thus allowing the product to have an adjustable outer diameter.

In an embodiment, each of the support strips is the rectangular prism structure, the number of the support strips is N, where N=180°/arctan(a/d), or N=(2πr)/a, r represents an outer radius of the inner reinforcement layer, a represents a width of each of the support strips, d represents the outer radius of the inner reinforcement layer, and h represents a height of the support layer (i.e., the thickness of the support layer). The parameters can be flexibly adjusted according to product specifications, thus allowing the product to have an adjustable outer diameter. A gap between tops of two adjacent support strips of the support strips is w, w=ax (h/r). The smaller the width of each of the support strips, the smaller the gaps formed at outer ends of the support layer. When the gaps are within a certain range, the strength of the outer structural layer is sufficient to support the external printing pressure, and thus the gaps may not need to be filled. Additionally, the gaps at the outer ends of the support layer can also be filled with support strips which are triangular prism-shaped.

In an embodiment, the plate material is a lightweight and high-strength material. The lightweight and high-strength material includes one or more selected from the group consisting of polymethacrylimide (PMI), polyvinyl chloride (PVC) and polyurethane, and is not limited to above three materials. The lightweight and high-strength material can be any other solid and rigid conventional materials, and materials with low density, high strength, and minimal deformation.

In an embodiment, the manufacturing method of the laminated sleeve further includes: preparing the inner reinforcement layer, including:
wrapping a glass fiber fabric onto an outer peripheral surface of the base sleeve, coating epoxy resin on a surface of the glass fiber fabric to impregnate and cure the glass fiber fabric to thereby form the inner reinforcement layer, where the base sleeve includes a basic sleeve and an elastic layer which are sequentially arranged in that order from inside to outside.

In an embodiment, the manufacturing method of the laminated sleeve further includes:
preparing the outer reinforcement layer, including: wrapping a glass fiber fabric onto an outer peripheral surface of the support layer, coating epoxy resin on a surface of the glass fiber fabric wrapped on the support layer to impregnate and cure the glass fiber fabric wrapped on the support layer to form the outer reinforcement layer.

In an embodiment, the manufacturing method of the laminated sleeve further includes:
coating epoxy resin on a surface of the outer reinforcement layer and curing the epoxy resin to form a surface layer.

The disclosure provides a second technical solution being the laminated sleeve manufactured by the manufacturing method of the laminated sleeve in the first technical solution. The specific technical solution is as follows.

The laminated sleeve includes: the basic sleeve, the elastic layer, the inner reinforcement layer, the support layer and the outer reinforcement layer, which are sequentially arranged in that order from inside to outside. The support layer includes the support strips, and the support strips are arranged in the isoperimetric manner between the inner reinforcement layer and the outer reinforcement layer.

In an embodiment, an outer peripheral surface of the outer reinforcement layer is provided with the surface layer.

The disclosure has the following beneficial effects: As a support layer for the laminated sleeve, the following conditions need to be met: 1. A weight of the support layer is lighter; 2. The support layer has a wide thickness change range; 3. The support layer has a simple manufacturing process, low cost and short cycle; 4. The support layer is not prone to deform, and have a small coefficient of thermal expansion and contraction. The above conditions are related to material selection and manufacturing process of the support layer. The manufacturing method of the laminated sleeve provided by the disclosure achieves the extensive selectivity of materials for the support layer, breaking through the limitations of material selection for the support layer in existing manufacturing methods for laminated sleeves. The disclosure can utilize the most commonly available formed plate (block) materials on the market as application materials and can use common general-purpose equipment, without the need for specialized operating skills or special preparation processes. The manufacturing method greatly expands the selectivity of materials for the support layer, especially offering extensive choices and applications for new materials. Moreover, the manufacturing method has the advantages of low investment in production equipment, low manufacturing costs, low energy consumption, and a short process cycle. The support layer of the laminated sleeve made by the disclosure can be made of conventional plate materials with low density, high strength, and minimal deformation, thus significantly reducing the weight of the laminated sleeve, achieving equipment lightening, increasing the rotational speed of the roller, and reducing the energy consumption of the roller while maintaining the structural strength and toughness of the sleeve. This, in turn, enhances the fatigue resistance and impact resistance of the laminated sleeve, prolonging the service life of the laminated sleeve and reducing the requirements for the operating environment temperature, which is beneficial for energy saving in workshop environmental temperatures.

### BRIEF DESCRIPTION OF DRAWINGS

FIG. 1 illustrates a schematic three-dimensional structural diagram of a plate material used in manufacturing a laminated sleeve according to an embodiment 1 of the disclosure.

FIG. 2 illustrates a schematic three-dimensional structural diagram of support strips obtained by cutting the plate material according to the embodiment 1 of the disclosure.

FIG. 3 illustrates a schematic diagram of a calculation principle of a number of the support strips according to the embodiment 1 of the disclosure.

FIG. 4 illustrates a schematic diagram of a calculation result of the number of the support strips according to the embodiment 1 of the disclosure.

FIG. 5 illustrates a schematic three-dimensional structural diagram of the laminated sleeve according to the embodiment 1 of the disclosure.

FIG. 6 illustrates a schematic three-dimensional structural diagram of support strips obtained by cutting the plate material according to an embodiment 2 of the disclosure.

FIG. 7 illustrates a schematic diagram of a calculation principle of a number of the support strips according to the embodiment 2 of the disclosure.

FIG. 8 illustrates a schematic three-dimensional structural diagram of the laminated sleeve according to the embodiment 2 of the disclosure.

### DETAILED DESCRIPTION OF EMBODIMENTS

In order to clarify the purpose, technical solution, and advantages of the disclosure, the disclosure is further described in detail with reference to illustrated embodiments and the accompanying drawings.

### Embodiment 1

The specific technical solution of a manufacturing method of a laminated sleeve provided by the embodiment 1 is as follows.

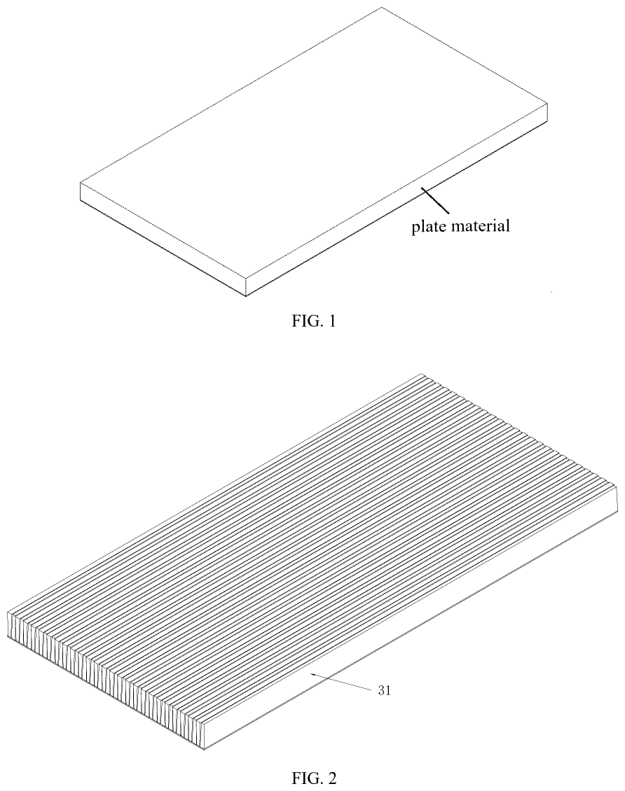

The manufacturing method of the laminated sleeve includes the following steps.
1. A formed plate material is selected, as shown in FIG. 1. The plate material in the embodiment 1 is a lightweight PMI rigid foam plate.
2. The plate material is cut into support strips 31 of desired dimensions which are frustum-shaped as needed by using a common woodworking saw or a hot-wire cutter (as shown in FIG. 2). The number of the support strips 31 is N, N=180°/arctan(l/2r). α represents an angle between two support strips 31, l represents a minimum width of each of the support strips 31, L represents a maximum width of each of the support strips 31, r represents an outer radius of an inner reinforcement layer 2, and h represents a thickness of a support layer 3.

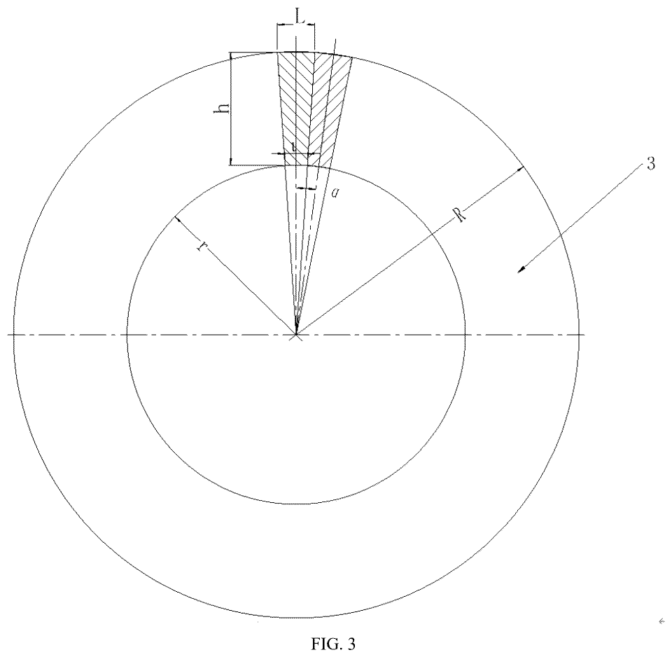

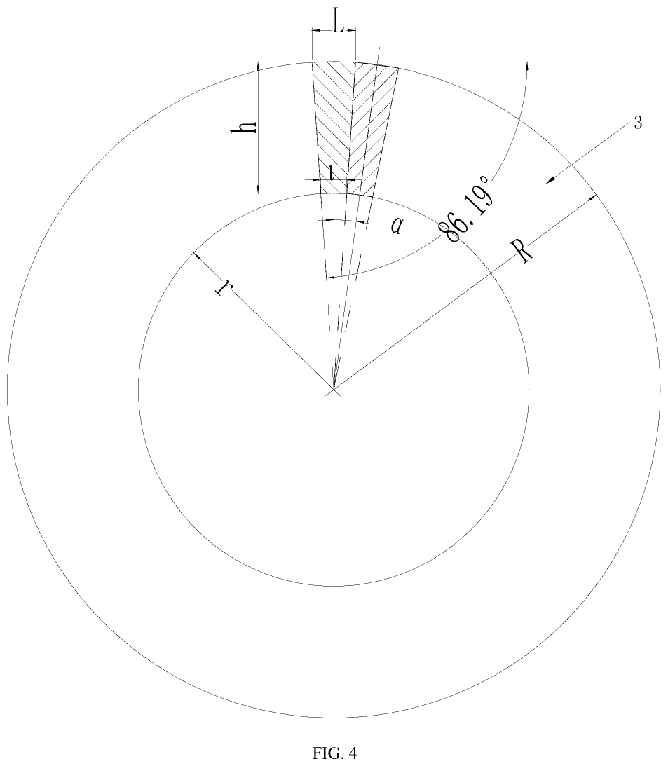

As shown in FIG. 3, in the embodiment 1, since the geometric relationship approximately satisfies L/l=(r+h)/r, it follows that L=l(r+h)/r. tan(α/2)=(L/2)/(r+h)=l(r+h)r/2(r+h). After substituting the values, α/2 can be calculated using a calculator, and thus α can be determined.

It should be noted that, in similar triangles, a ratio of bases is equal to a ratio of heights, i.e., L/l=(r+h)/r, α/2 can be calculated using a tangent function to thereby calculate α. By substituting r=75, l=10, h=50, α is calculated to be 7.63°.

As shown in FIG. 4, the number of frustums which are equally divided is N=360°/a, the number of frustums is obtained by dividing the circumference by α, and the inclination angle of each frustum is (180°−α)/2. In the isosceles triangle in FIG. 4, given α, the angle between an oblique side in the frustum and L is obtained by first calculating 180°−α followed by dividing the result of 180°−α by 2. By substituting the above data that α=7.63°, the inclination angle of each frustum is calculated to be 86.19°.
3. A glass fiber fabric is wrapped and adhered onto a roll surface of a base sleeve 1 to form the inner reinforcement layer 2. The base sleeve 1 includes a basic sleeve 11 and an elastic layer 12 which are sequentially arranged in that order from inside to outside.
4. The support strips 31 are arranged neatly around the inner reinforcement layer 2 and then adhered onto the inner reinforcement layer 2 to form the support layer 3; or the support strips 31 are arranged neatly around the inner reinforcement layer 2 and then wrapped and bundled with a glass fiber tape onto the inner reinforcement layer 2 to form the support layer 3.
5. A glass fiber fabric is wrapped around the support layer 3 for multiple turns, epoxy resin is coated on the glass fiber fabric wrapped on the support layer 3 to impregnate and cure the glass fiber fabric wrapped on the support layer 3 to form an outer reinforcement layer 4 to thereby obtain a sleeve prototype. (As shown in FIG. 3 and FIG. 4, an inner radius of the outer reinforcement layer 4 is R.)
6. The sleeve prototype is cut to define end surfaces of the laminated sleeve and define fix a length of the laminated sleeve.
7. The end surfaces of the laminated sleeve is processed.
8. An outer cylindrical surface of the outer reinforcement layer 4 is polished.
9. Epoxy resin is coated on a surface of the outer reinforcement layer 4 and then cured to form a surface layer 5.

The laminated sleeve manufactured in the embodiment 1 is shown in FIG. 5. The laminated sleeve includes the basic sleeve 11, the elastic layer 12, the inner reinforcement layer 2, the support layer 3, the outer reinforcement layer 4 and the surface layer 5 which are sequentially arranged in that order from inside to outside. The support layer 3 includes the support strips 31, and the support strips 31 are around the central axis of the base sleeve 1 and covers the inner reinforcement layer 2 completely. The basic sleeve 11 and the elastic layer 12 endow the laminated sleeve with the function of air expansion assembly, enabling the laminated sleeve to connect with an air-expanding mandrel.

### Embodiment 2

The specific technical solution of a manufacturing method of a laminated sleeve provided by the embodiment 2 is as follows.

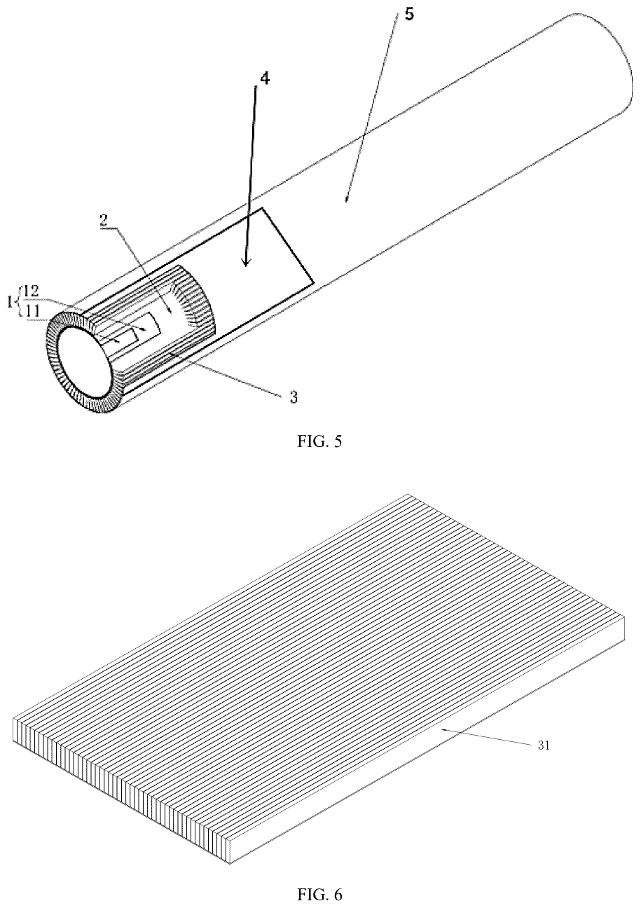

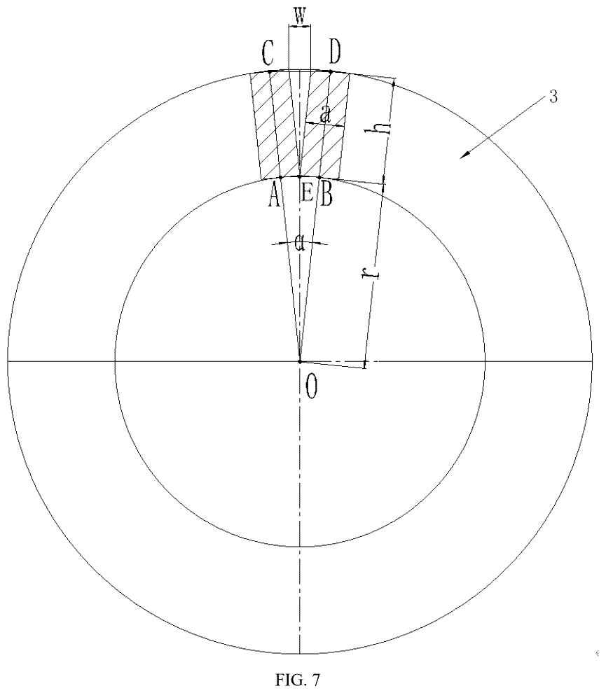

The manufacturing method of the laminated sleeve includes the following steps.
1. A formed plate material is selected, as shown in FIG. 1. The plate material in the embodiment 2 is a lightweight PMI rigid foam plate.
2. A common woodworking saw or a hot-wire cutter can be used to cut the plate material according to designed dimensions as needed. Specifically, an outer circumference of an inner reinforcement layer 2 is equally divided to obtain an integer number of support strips 31 which are rectangular-shaped (FIG. 6). The number of the support strips 31 is N, N=180°/arctan(α/r), or N=(2πr)/a, The smaller a width of each support strip 31, the smaller the gaps formed at outer ends of a support layer 3. Therefore, the support strips 31 which are rectangular-shaped should be cut to as small a width as possible. As shown in FIG. 7, in the embodiment 2, in the triangle AEO, ∠OAE is a right angle, thus tan(α/2)=α/2/r. After substituting values, α/2 can be obtained through a calculator, and a is thereby calculated. The number of the support strips 31 is N=360°/α, by substituting α=10, r=75, h=50, tan(α/2)=10/2/75, it is calculated that α=7.63°, and N=47, i.e., the number of the support strips 31 is 47. Specifically, a represents a width of each of the support strips 31, α represents an angle between two support strips 31, r represents an outer radius of the inner reinforcement layer 2, and h represents a thickness of the support layer 3.
3. A glass fiber fabric is wrapped and adhered onto a roll surface of a base sleeve 1 to form the inner reinforcement layer 2. The base sleeve 1 includes a basic sleeve 11 and an elastic layer 12 which are sequentially arranged in that order from inside to outside.
4. The support strips 31 are arranged neatly around the inner reinforcement layer 2 and then adhered onto the inner reinforcement layer 2 to form the support layer 3; or the support strips 31 are arranged neatly around the inner reinforcement layer 2 and then wrapped and bundled with a glass fiber tape onto the inner reinforcement layer 2 to form the support layer 3.
5. A glass fiber fabric is wrapped around the support layer 3 for multiple turns, epoxy resin is coated on the glass fiber fabric wrapped on the support layer 3 to impregnate and cure the glass fiber fabric wrapped on the support layer 3 at room temperature to form an outer reinforcement layer 4 to thereby obtain a sleeve prototype.
6. The sleeve prototype is cut to define end surfaces of the laminated sleeve and define a length of the laminated sleeve.
7. The end surfaces of the laminated sleeve is processed.
8. An outer cylindrical surface of the outer reinforcement layer 4 is polished.
9. Epoxy resin is coated on a surface of the outer reinforcement layer 4 and then cured to obtain a surface layer 5.

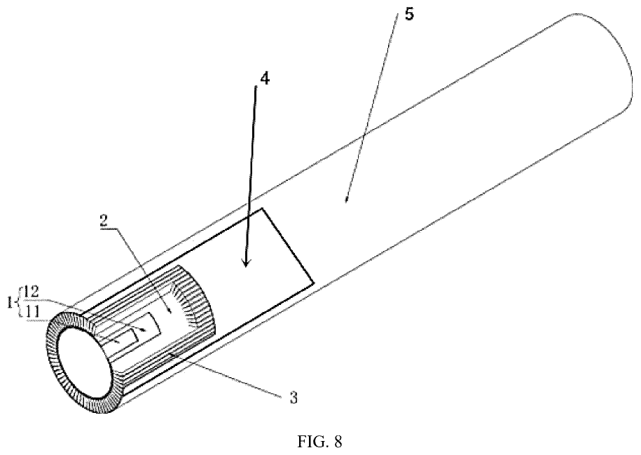

The laminated sleeve manufactured in the embodiment 2 is shown in FIG. 8. The laminated sleeve includes the basic sleeve 11, the elastic layer 12, the inner reinforcement layer 2, the support layer 3, the outer reinforcement layer 4 and the surface layer 5 which are sequentially arranged in that order from inside to outside. The support layer 3 includes the support strips 31, and the support strips 31 are around the central axis of the base sleeve 1 and covers the inner reinforcement layer 2 completely. The basic sleeve 11 is used for subsequent connection with an air-expanding mandrel, and the elastic layer 12 gives the laminated sleeve a certain degree of elasticity as a whole, making it suitable for flexographic printing.

In summary, the disclosure can utilize the most commonly available formed plate materials (blocks) on the market as application materials and can be manufactured using common general equipment, without the need for specialized operating skills or special preparation processes. The manufacturing method greatly expands the wide range of material choices for the support layer 3, especially offering extensive selection and application advantages for new materials, and thus allowing for flexible adjustment of the outer diameter size of the product. Moreover, the manufacturing method features low equipment investment, low manufacturing costs, low energy consumption, and a short process cycle. The support layer 3 of the laminated sleeve made by the disclosure can be made of materials with low density, high strength, and minimal deformation, thus significantly reducing the weight of the laminated sleeve, achieving equipment lightening, facilitating quick loading and unloading of the sleeve, increasing the rotational speed of the roller, and reducing the energy consumption of the roller while maintaining the structural strength and stability of the sleeve. This, in turn, enhances the fatigue resistance and impact resistance of the sleeve, prolongs its service life, and reduces the requirements for the operating environment temperature, which is advantageous for energy saving in workshop environmental temperatures.

The above are only the illustrated embodiments of the disclosure, and are not intended to limit the disclosure. The disclosure is not limited to the above examples, and any changes, modifications, additions, or substitutions made by those skilled in the art within the essential scope of the disclosure should also fall within the scope of protection of the disclosure.

What is claimed is:

1. A manufacturing method of a laminated sleeve, comprising:
cutting a plate material into support strips, arranging the support strips in an isoperimetric manner around a central axis of the laminated sleeve and between an inner reinforcement layer and an outer reinforcement layer to form a support layer, comprising:
wrapping and adhering a glass fiber fabric onto a roll surface of a base sleeve to form the inner reinforcement layer, arranging neatly the support strips around the inner reinforcement layer, and adhering arranged support strips onto the inner reinforcement layer to form the support layer; or,
wrapping and adhering a glass fiber fabric onto a roll surface of a base sleeve to form the inner reinforcement layer, arranging neatly the support strips around the inner reinforcement layer, and wrapping and bundling arranged support strips with a glass fiber tape onto the inner reinforcement layer to form the support layer;
wherein each of the support strips is a frustum structure, or each of the support strips is a rectangular prism structure;
wherein when each of the support strips is the frustum structure, a number of the support strips is N, where N=180°/arctan(½r), r represents an outer radius of the inner reinforcement layer, l represents a minimum width of each of the support strips, l=Lr/(r+h), L represents a maximum width of each of the support strips, and h represents a thickness of the support layer;
wherein when each of the support strips is the rectangular prism structure, the number of the support strips is N, where N=(2πr)/α, and r represents an outer radius of the inner reinforcement layer; and a gap between tops of two adjacent support strips of the support strips is w, where w=a×(h/r), α represents a width of each of the support strips, and h represents a thickness of the support layer.

2. The manufacturing method of the laminated sleeve as claimed in claim 1, wherein the plate material is a lightweight and high-strength material.

3. The manufacturing method of the laminated sleeve as claimed in claim 1, wherein the wrapping and adhering a glass fiber fabric onto a roll surface of a base sleeve to form the inner reinforcement layer comprises:
wrapping the glass fiber fabric onto an outer peripheral surface of the base sleeve, coating epoxy resin on a surface of the glass fiber fabric to impregnate and cure the glass fiber fabric to thereby form the inner reinforcement layer, wherein the base sleeve comprises a basic sleeve and an elastic layer which are sequentially arranged in that order from inside to outside.

4. The manufacturing method of the laminated sleeve as claimed in claim 1, further comprising:
preparing the outer reinforcement layer, comprising: wrapping a glass fiber fabric onto an outer peripheral surface of the support layer, coating epoxy resin on a surface of the glass fiber fabric wrapped on the support layer to impregnate and cure the glass fiber fabric wrapped on the support layer to form the outer reinforcement layer.

5. The manufacturing method of the laminated sleeve as claimed in claim 1, further comprising: coating epoxy resin on a surface of the outer reinforcement layer and curing the epoxy resin to form a surface layer.

6. The manufacturing method of the laminated sleeve as claimed in claim 5, further comprising:
before the coating epoxy resin on a surface of the outer reinforcement layer for cure to obtain a surface layer, processing end surfaces of the laminated sleeve, and polishing an outer cylindrical surface of the outer reinforcement layer.

7. The manufacturing method of the laminated sleeve as claimed in claim 1, wherein the plate material comprises one or more selected from the group consisting of polymethacrylimide (PMI), polyvinyl chloride (PVC) and polyurethane.

8. A laminated sleeve with a support layer of a spliced structure, wherein the laminated sleeve is manufactured by the manufacturing method of the laminated sleeve as claimed in claim 1, and the laminated sleeve comprises: a basic sleeve, an elastic layer, the inner reinforcement layer, the support layer and the outer reinforcement layer which are sequentially arranged in that order from inside to outside;
wherein the support layer comprises the support strips, and the support strips are arranged in the isoperimetric manner and disposed between the inner reinforcement layer and the outer reinforcement layer.

9. The laminated sleeve with the support layer based on the spliced structure as claimed in claim 8, wherein an outer peripheral surface of the outer reinforcement layer is provided with a surface layer.

10. A manufacturing method of a laminated sleeve, comprising:
selecting a plate material;
cutting the plate material into support strips which are frustum-shaped, wherein a number of the support strips is N, where N=180°/arctan(lr/2), l represents a minimum width of each of the support strips, and r represents an outer radius of an inner reinforcement layer;
wrapping and adhering a glass fiber fabric onto a roll surface of a base sleeve to form the inner reinforcement layer;
arranging the support strips in an isoperimetric manner around a central axis of the base sleeve, and fixing arranged support strips onto the inner reinforcement layer to form a support layer;
wrapping a glass fiber fabric around the support layer for multiple turns, and coating epoxy resin on the glass fiber fabric wrapped on the support layer to impregnate and cure the glass fiber fabric wrapped on the support layer to form an outer reinforcement layer to thereby obtain a sleeve prototype;
cutting the sleeve prototype to define end surfaces of the laminated sleeve and define a length of the laminated sleeve;
processing the end surfaces of the laminated sleeve;
polishing an outer cylindrical surface of the outer reinforcement layer; and
coating epoxy resin on a surface of the outer reinforcement layer and curing the epoxy resin to obtain a surface layer to thereby form the laminated sleeve.

11. The manufacturing method of the laminated sleeve as claimed in claim 10, wherein the plate material is PMI.

12. The manufacturing method of the laminated sleeve as claimed in claim 10, wherein the base sleeve comprises: a basic sleeve and an elastic layer which are sequentially arranged in that order from inside to outside of the base sleeve.

13. The manufacturing method of the laminated sleeve as claimed in claim 10, wherein the arranging the support strips in an isoperimetric manner around a central axis of the base sleeve, and fixing arranged support strips onto the inner reinforcement layer to form a support layer comprises:
arranging neatly the support strips around the inner reinforcement layer, and adhering the arranged support strips onto the inner reinforcement layer to form the support layer.

14. The manufacturing method of the laminated sleeve as claimed in claim 10, wherein the arranging the support strips in an isoperimetric manner around a central axis of the base sleeve, and fixing arranged support strips onto the inner reinforcement layer to form a support layer comprises:
arranging neatly the support strips around the inner reinforcement layer, and wrapping and bundling the arranged support strips with a glass fiber tape onto the inner reinforcement layer to form the support layer.

15. A manufacturing method of a laminated sleeve, comprising:
selecting a plate material;
cutting the plate material into support strips which are frustum-shaped;
wrapping and adhering a glass fiber fabric onto a roll surface of a base sleeve to form the inner reinforcement layer;
arranging the support strips in an isoperimetric manner around a central axis of the base sleeve, and fixing arranged support strips onto the inner reinforcement layer to form a support layer;
wrapping a glass fiber fabric around the support layer for multiple turns, and coating epoxy resin on the glass fiber fabric wrapped on the support layer to impregnate and cure the glass fiber fabric wrapped on the support layer to form an outer reinforcement layer to thereby obtain a sleeve prototype;
cutting the sleeve prototype to define end surfaces of the laminated sleeve and define a length of the laminated sleeve;
processing the end surfaces of the laminated sleeve;
polishing an outer cylindrical surface of the outer reinforcement layer; and
coating epoxy resin on a surface of the outer reinforcement layer and curing the epoxy resin to form a surface layer, to thereby form the laminated sleeve;
wherein a number of the support strips is N, where N=(2πr)/α, α represents a width of each of the support strips, and r represents an outer radius of the inner reinforcement layer.

16. The manufacturing method of the laminated sleeve as claimed in claim 15, wherein the plate material is PMI.

17. The manufacturing method of the laminated sleeve as claimed in claim 15, wherein the base sleeve comprises: a basic sleeve and an elastic layer which are sequentially arranged in that order from inside to outside of the base sleeve.

18. The manufacturing method of the laminated sleeve as claimed in claim 15, wherein the arranging the support strips in an isoperimetric manner around a central axis of the base sleeve, and fixing arranged support strips onto the inner reinforcement layer to form a support layer comprises:
arranging neatly the support strips around the inner reinforcement layer, and adhering the arranged support strips onto the inner reinforcement layer to form the support layer.

19. The manufacturing method of the laminated sleeve as claimed in claim 15, wherein the arranging the support strips in an isoperimetric manner around a central axis of the base sleeve, and fixing arranged support strips onto the inner reinforcement layer to form a support layer comprises:
arranging neatly the support strips around the inner reinforcement layer, and wrapping and bundling the arranged support strips with a glass fiber tape onto the inner reinforcement layer to form the support layer.

20. The manufacturing method of the laminated sleeve as claimed in claim 15, wherein the glass fiber fabric wrapped on the support layer is cured at room temperature.
